(19) United States
(12) Patent Application Publication
(10) Pub. No.: US 2024/0308780 A1
(43) Pub. Date: Sep. 19, 2024

(54) CONVEYOR SYSTEM FOR CONVEYING GOODS TO BE CONVEYED

(71) Applicant: PROVISUR TECHNOLOGIES, INC., Chicago, IL (US)

(72) Inventors: Jürgen BIALY, Oeschebüttel (DE); Klaus GUGGEMOS, Rettenberg (DE); Paul GOROLL, Waltenhofen (DE); Matthias HINDORFF, Waltenhofen (DE); Alexander MAY, Waltenhofen (DE); Florian MOHR, Sulzberg (DE); Klaus Dieter SCHROFF, Konstanz (DE)

(21) Appl. No.: 18/548,901

(22) PCT Filed: Feb. 17, 2022
(86) PCT No.: PCT/EP2022/053953

§ 371 Date: Sep. 3, 2023

(30) Foreign Application Priority Data
Mar. 3, 2021 (DE) 10 2021 105 105.3

(51) Int. Cl. B65G 35/06; B65G 37/00; B65G 54/02

(52) U.S. Cl. CPC B65G 35/06; B65G 37/00; B65G 54/02

(57) ABSTRACT

The invention relates to a conveyor system (1) for conveying products to be conveyed, in particular for conveying food products in a food processing installation, with at least one continuous conveyor (5, 6) for continuously conveying the products to be conveyed, in particular as a belt conveyor. The invention provides for a combination with a discontinuous conveyor (4), which is connected to the continuous conveyor (5, 6) on the input or output-side and takes over the conveyed products from the continuous conveyor (5, 6) or passes it on to the continuous conveyor (5, 6).

The invention relates to a conveyor system for conveying products to be conveyed, in particular for conveying food products (e.g. stacks of slices of meat or cheese) in a food processing installation.

In modern food processing installations for processing food products (e.g. pieces of meat, pieces of cheese, sausage sticks, etc.), cutting devices, also referred to as “slicers”, are used for slicing the food products. The slices cut by the slicer are then conveyed in various possible portion shapes (e.g. stacks of slices, shingles, etc.) to a packaging machine (e.g. thermoforming machine) where they are packaged. The food products are usually transported between the cutting device and the packaging machine by conveyor belts, which also fulfill other functions, such as buffering the food portions between the cutting device and the packaging machine and formatting the food portions into the desired portion shape (e.g. slice stacks, shingles, twin pack with two portions in one pack, etc.). However, the fulfillment of these further functions is relatively difficult to achieve with conveyor belts. The conveyor between the cutting device and the packaging machine is therefore a so-called continuous conveyor.

Furthermore, it is known from the prior art to transport the food products by so-called “shuttles” from the cutting device to the packaging machine. The individual “shuttles” are conveyed-products carriers that can each hold one or more portions of the food products in order to transport them along a fixed conveying path to the packaging machine. The conveyor between the cutting device and the packaging machine is therefore a discontinuous conveyor, which has specific advantages and disadvantages.

The above-mentioned known types of conveyors (continuous conveyors and discontinuous conveyors) each have specific advantages and disadvantages.

Regarding the technical background of the invention, reference should also be made to DE 10 2014 106 400 A1.

The invention is therefore based on the task of creating a correspondingly improved conveyor system.

This task is solved by a conveyor system according to the invention and in accordance with the main claim.

First of all, it should be noted that the conveyor system according to the invention is generally suitable for conveying products to be conveyed. However, the preferred field of application of the conveyor system according to the invention consists in conveying food products (e.g. portions of cheese pieces, meat pieces or sausage pieces) in a food processing installation. Therefore, in a preferred embodiment, the conveying system according to the invention is designed to convey food products in a food processing installation, which is associated with certain hygiene requirements.

Furthermore, it should be noted that the conveyor system according to the invention comprises at least one continuous conveyor for continuously conveying the products to be conveyed, in accordance with the known conveyor system described at the beginning. In the preferred embodiment of the invention, the continuous conveyor is designed as a belt conveyor, but other types of continuous conveyors are also possible in principle within the scope of the invention.

The conveyor system according to the invention is now distinguished from the prior art in that the conveyor system additionally has at least one discontinuous conveyor, which is connected to the continuous conveyor (e.g. conveyor belt) on the input-side and/or output-side and takes over the products to be conveyed from the continuous conveyor or passes it on to the continuous conveyor. The invention thus combines the two known types of conveyors (continuous conveyors and discontinuous conveyors), exploiting the advantages of both types while avoiding the specific disadvantages of each.

In the preferred embodiment of the invention, the discontinuous conveyor has at least one conveyed-products carrier which serves to receive the products to be conveyed. Such conveyed-products carriers are also referred to as “shuttles” or “movers” according to the usual technical terminology.

The individual conveyed-products carriers can be moved along a conveying path within a conveying surface, whereby the conveying path is preferably freely programmable within the conveying surface, as is the case with the so-called “movers” of the “XPlanar” planar motor drive system, which is marketed by the German company Beckhoff Automation GmbH. In contrast to the known conveyor system with the rail-guided “shuttles” described at the beginning, the discontinuous conveyor in the conveyor system according to the invention thus preferably allows free movement of the individual conveyed-products carriers within the conveying surface.

It should be mentioned here that the conveying surface is horizontally aligned in the preferred embodiment. However, it is alternatively also possible that the conveying surface is aligned vertically or obliquely.

In the preferred embodiment of the invention, the discontinuous conveyor comprises a contactless drive system which serves to move the individual conveyed-products carriers along the conveying path without a touching contact between the conveyed-products carrier on the one hand and the conveying surface on the other hand. For example, the contactless drive system can be designed as a magnetic levitation system and have several modules that can be directly adjacent to each other and then form a continuous conveying surface. In this case, the individual modules of the drive system are preferably rectangular, so that the modules can optionally be assembled without gaps to form the continuous conveying surface. Such a contactless drive system is sold, for example, by the German company Beckhoff Automation GmbH under the product name “XPlanar”, so that a detailed description of the details of the contactless drive system can be dispensed with, since this is in itself known from the prior art.

In the preferred embodiment of the invention, a delivery conveyor is provided which serves to deposit the conveyed product on the discontinuous conveyor, the delivery conveyor preferably being a belt conveyor. The delivery conveyor thus preferably takes over the portions (e.g. stacks of slices) of the food products and deposits them on one of the conveyed-product carriers of the discontinuous conveyor.

In addition, in the preferred embodiment of the invention, a take-off conveyor is preferably provided, which serves to remove the conveyed product again from the discontinuous conveyor, the take-off conveyor also preferably being designed as a belt conveyor. The take-off conveyor can then convey the portions (e.g. stacks of slices, shingles, etc.) of the food products to the packaging machine, for example.

It should be mentioned here that the take-off conveyor and/or the delivery conveyor can consist of several conveyor belts, which are preferably arranged next to each other and are each relatively narrow, so that the individual conveyor belts of the take-off conveyor or delivery conveyor can also be referred to as finger conveyors or knife conveyors.

With regard to the constructional design and the mode of operation of the take-off conveyor under the individual conveyed-products carriers, reference is made to the German patent application DE 10 2020 105 678.8, the contents of which are to be fully attributed to the present description with regard to the construction and the mode of operation of the take-off conveyor and the individual conveyed-products carriers.

At this point, it is only necessary to mention that the removal of the portions of the food products from the conveyed-product carriers by simple conveyor belts is relatively difficult. In the preferred embodiment of the invention, the take-off conveyor therefore has several parallel conveyor belts, each of which is relatively narrow and may also be referred to as a knife conveyor or finger conveyor. These narrow conveyor belts of the take-off conveyor can then be introduced into elongated parallel recesses in the loading surface of the conveyed-product carrier, in order to engage underneath and convey away the portions of the food products lying on the loading surface of the conveyed-product carrier. The elongated recesses in the loading surface of the conveyed-products carrier are therefore preferably wider than the individual narrow conveyor belts of the take-off conveyor, so that the individual conveyor belts of the take-off conveyor can dive into the elongated recesses in the loading area of the conveyed-products carrier in order to reach under the portions of the food product lying on the loading surface. In this case, the gap between the immediately adjacent conveyor belts of the take-off conveyor is preferably larger than the distance between the immediately adjacent recesses in the conveyor carrier.

In the preferred embodiment of the invention, the conveyed-product carrier has on its upper side a plurality of pins which project upwardly from the conveyed-product carrier and enclose between them the elongated recesses, the free end faces of the pins forming the loading surface for supporting the food products. The pins can be arranged in a matrix in pin rows and pin columns, the pin rows and pin columns preferably being arranged at right angles to one another. The directly adjacent pin rows can enclose the elongated recesses between them in pairs, into which the narrow conveyor belts of the take-off conveyor can then dive. It should also be mentioned that the pins preferably have the same length and project upwards at right angles from the loading surface so that the pins are aligned parallel to each other. It should also be mentioned that the pins can have a round or an angular cross-section.

In the preferred embodiment of the invention, the delivery conveyor, the take-off conveyor and the discontinuous conveyor are integrated together in a stand-alone device. This is to be distinguished from conveyor systems which have the delivery conveyor, the take-off conveyor and the discontinuous conveyor as separate devices which are merely arranged one behind the other along a conveyor line and interact with each other. In the stand-alone device according to the invention, the delivery conveyor, the take-off conveyor and the discontinuous conveyor thus preferably rest on a common stand. Here, the discontinuous conveyor may have a housing, wherein the delivery conveyor and/or the receiving conveyor are optionally attached laterally to the housing of the discontinuous conveyor.

Furthermore, it should be mentioned that the delivery conveyor is preferably pivotable between a delivery position and a stand-by position. In this case, the delivery position is used to deposit the conveyed products on a conveyed-products carrier. The delivery position is therefore relatively close to the conveying surface, i.e. the delivery conveyor is swiveled downward into the delivery position. The stand-by position, on the other hand, is away from the conveying surface so that the delivery conveyor in the stand-by position does not impede the free movement of the conveyed-product carriers on the conveying surface of the non-stop conveyor. In the delivery position, the delivery conveyor can also be additionally height-adjustable.

In the same way, the take-off conveyor can preferably also be swiveled between a take-off position on the one hand and a stand-by position on the other. The take-off position is used to remove a portion (e.g. stacks of slices, shingles, etc.) of the food product lying on a conveyed-products carrier from the conveyed-products carrier and to convey it away. The take-off position is therefore relatively close to the conveying surface, i.e. the take-off conveyor is swiveled downwards into the take-off position. The stand-by position of the take-off conveyor, on the other hand, is relatively far away from the conveying surface so that the free movement of the conveyed-products carriers on the conveying surface is not impeded by the take-off conveyor in the stand-by position. In the take-off position, the height of the take-off conveyor can also be adjusted.

In the case of a horizontal alignment of the conveying surface, the delivery conveyor and the take-off conveyor can preferably be pivoted in a vertical direction.

From the foregoing description of the conveyor system according to the invention, it is already apparent that the conveyor system is preferably used in a food processing installation to convey food products. The invention therefore also claims protection for a food processing installation with such a conveyor system according to the invention for conveying food products.

In the preferred embodiment of the invention, the food processing installation comprises a cutting device which serves to slice the food products (e.g. pieces of meat, pieces of cheese, pieces of sausage, sticks of salami, etc.), such cutting devices being known per se from the prior art and also being referred to as “slicers” in accordance with the usual technical terminology.

The slices cut off by the cutting device are then preferably first deposited on a receiving conveyor, this preferably being a belt conveyor, as is known per se from the prior art. Alternatively, however, it is also possible for the slices to be deposited directly on a conveyed-products carrier of the discontinuous conveyor.

In addition, the food processing installation according to the invention preferably also comprises a packaging machine for packaging the portions of the food products in food packages. For example, the packaging machine may be a thermoforming machine as known per se from the prior art. Alternatively, however, it is also possible for the packaging machine to be a form fill and seal machine or a so-called tray sealer, these types of packaging machines also being known per se from the prior art. The invention is therefore not limited to a particular type of packaging machine.

One of the aforementioned continuous conveyors (e.g. belt conveyor) then conveys the portions of the food products to the packaging machine, where the portions are then packaged.

Furthermore, it should be mentioned that a buffer conveyor can be arranged downstream of the cutting device in order to buffer the food products, whereby the buffer conveyor can optionally be designed as a continuous conveyor (e.g. belt conveyor) or as a discontinuous conveyor, for example corresponding to the magnetic levitation system described above. Furthermore, it should be mentioned that the buffer conveyor can also be arranged before or after the discontinuous conveyor (e.g. planar motor drive system “XPlanar”).

In addition, the conveyor system according to the invention can have a formatting conveyor in the food processing installation, which receives the food products on the input-side in a specific input-side product format, formats them and discharges them on the output-side in a specific output-side product format, the formatting conveyor being designed as a discontinuous conveyor. The formatting function can thus be performed in the food processing installation according to the invention by the discontinuous conveyor, whereby the food processing installation according to the invention differs from the prior art, since otherwise complicated systems of belt conveyors are used for this purpose.

For example, the input-side and output-side product formats may differ by the number of conveyor tracks. For example, the food portions can be delivered on the input-side by the “slicer” with three conveyor tracks, whereas the packaging machine can only process two parallel conveyor tracks. The discontinuous conveyor can therefore realize a format conversion from the three conveyor tracks on the input-side to the two conveyor tracks on the output-side, i.e. in a ratio of 3:2. Within the scope of the invention, however, other ratios for the format conversion can also be realized, such as 1:3, 1:4, 2:1, 2:3 or 2:4, where the first number represents the number of feed tracks on the input-side, while the second number represents the number of feed tracks on the output-side.

However, the food processing installation according to the invention does not only enable a format conversion with respect to the number of conveyor tracks. In addition, the food processing installation according to the invention preferably also enables product formatting so that the outgoing portions of the food products have a desired product format. For example, the portions may be formed as stacks of slices, the individual stacks of slices each comprising a plurality of slices of the food product stacked one on top of the other without a lateral offset between the stacked slices and/or optionally with an offset in the transport direction. Alternatively, it is also possible to output shingles consisting of several slices of the food product stacked on top of each other with a lateral offset between the stacked slices. Other possible product formats include round laid, overlapped slices or folded slices of the food product. Furthermore, staggered and overlapping slices can also be issued, each consisting of several slices of the food product stacked on top of each other with a lateral offset between the stacked slices. Finally, the food products can also be dispensed as so-called “shaved meat”, this product format being known per se from the prior art.

Other advantageous further embodiments of the invention are indicated in the dependent claims or are explained in more detail below together with the description of the preferred embodiment example of the invention with reference to the figures.

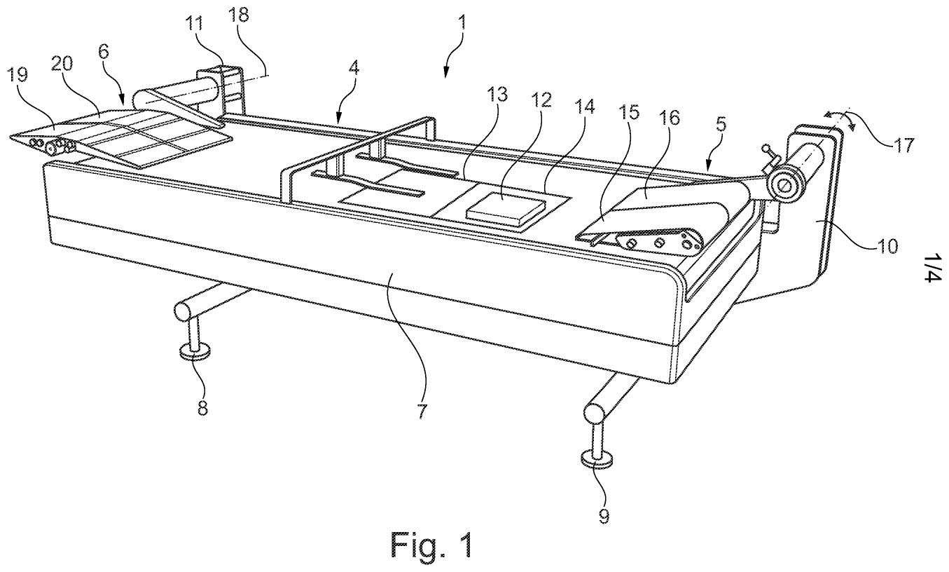

FIG. 1 shows a perspective view of a conveyor device according to the invention.

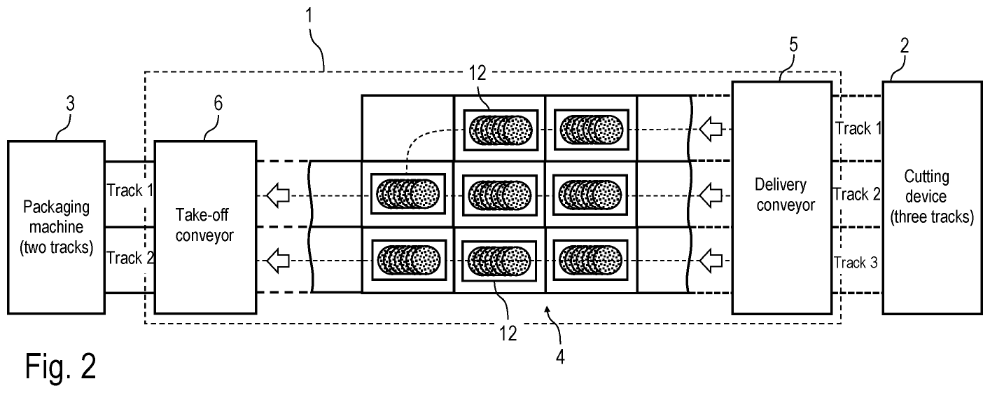

FIG. 2 shows a schematic representation of the use of the conveyor device from FIG. 1 in a food processing installation.

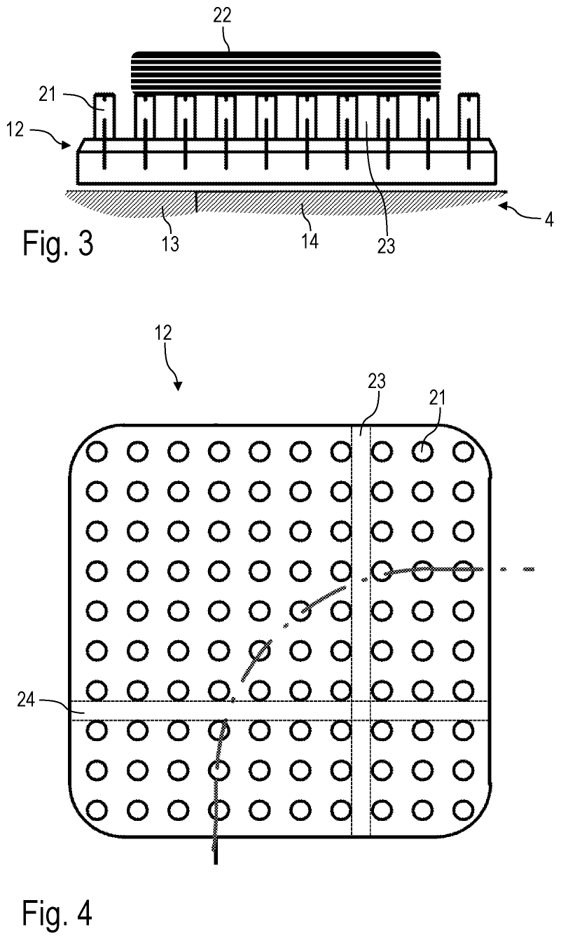

FIG. 3 shows a schematic side view of a conveyed-products carrier of the conveyor device of FIG. 1.

FIG. 4 shows a schematic top view of the conveyor carrier according to FIG. 3.

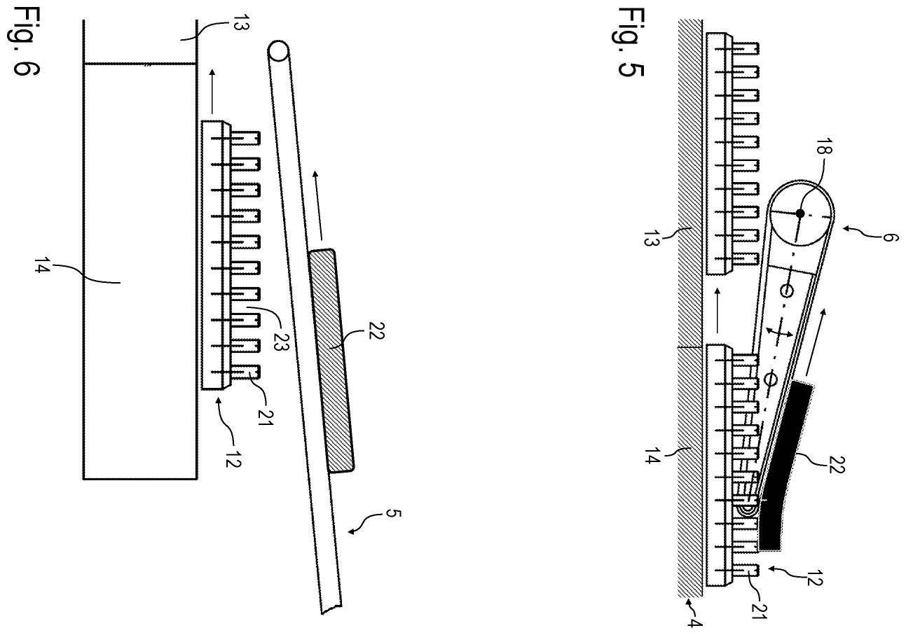

FIG. 5 shows a schematic side view of the take-off conveyor for taking off the food products from the conveyor carrier according to FIGS. 3 and 4.

FIG. 6 shows a schematic side view of the depositing conveyor for depositing the food products on the conveyed-products carrier.

FIG. 1 first shows a perspective view of a conveyor device 1 according to the invention, which can be used in a food processing installation to convey food products from a cutting device 2 (cf. FIG. 2) to a packaging machine 3. It should be mentioned here that further conveyors can be arranged between the cutting device 2 and the conveyor device 1 and also between the conveyor device 1 and the packaging machine 3, but this is not shown here for simplicity.

The conveyor device 1 essentially consists of a planar motor system 4, a delivery conveyor 5 and a take-off conveyor 6.

The conveyor device 1 is designed as a stand-alone device, i.e. the planar motor system 4, the delivery conveyor 5 and the take-off conveyor 6 are integrated in one device. For this purpose, the conveyor device 1 has a common housing 7 which rests on feet 8, 9, whereby only the two front feet 8, 9 are visible in the drawing, while the other two feet are covered by the housing 7. In this case, the delivery conveyor 5 is attached laterally to the housing 7 of the conveyor device 1 by means of a holding arm 10. Similarly, the take-off conveyor 6 is attached to the side of the housing 7 of the conveyor 1 by means of a holding arm 11.

The planar motor system 4 enables the movement of conveyed-product carriers 12 within a horizontal conveying surface, whereby the conveying path of the individual conveyed-product carriers 12 within the horizontal conveying surface is freely programmable. The planar motor system 4 can be obtained, for example, from the German company Beckhoff Automation GmbH under the product name “XPlanar”. At this point it is only to be mentioned that the planar motor system 4 has a magnetic levitation system, so that the individual conveyed-products carriers 12 are freely movable without a contact with the underlying conveying surface.

Furthermore, it should be mentioned that the conveying surface of the planar motor system 4 is composed of several rectangular modules 13, 14, so that almost any shape and size of the conveying surface can be realized. In the embodiment example according to FIG. 1, the entire conveying surface is rectangular. In the embodiment example according to FIG. 2, on the other hand, the conveying surface has a taper in the form of a shoulder to enable track conversion, as will be described in detail. Furthermore, it should be mentioned that a return track is optionally provided to return empty conveyed-product carriers 12, whereby the return track is not shown for simplification.

The delivery conveyor 5 essentially comprises two adjacent conveyor belts 15, 16, i.e. in this embodiment the delivery conveyor 5 has two tracks. However, it is also possible within the scope of the invention for the delivery conveyor 5 to be single-track or to have a larger number of conveyor tracks. Furthermore, it should be mentioned that the delivery conveyor 5 is pivotable in vertical direction about a horizontal swivel axis 17. For depositing portions (e.g. stacks of slices) of the food products, the delivery conveyor 5 is then pivoted downwards so that the portions of the food products can be deposited on one of the conveyed-products carriers 12. Otherwise, the delivery conveyor 5 is pivoted upwards into a stand-by position, in which the delivery conveyor does not impede the free movement of the food product carriers 12 on the conveying surface of the planar motor system 4.

The take-off conveyor 6 can also be swiveled in the vertical direction about a swivel axis 18 and also has two parallel conveyor belts 19, 20, i.e. in this embodiment the take-off conveyor 6 also has two tracks. This means that two conveyor tracks run in on the input-side and two conveyor tracks are discharged on the output-side. However, it is also possible within the scope of the invention that the number of conveyor tracks on the input-side differs from the number of conveyor tracks on the output-side. The take-off conveyor 6 serves to take off a portion of the food product from one of the conveyed-product carriers 12. For this purpose, the take-off conveyor 6 is swiveled downward, whereby the actual take-off process and the corresponding design of the take-off conveyor 6 and the conveyed-product carrier 12 are described in detail with reference to FIGS. 3-6. Reference is also made here to the German patent application DE 10 2020 105 678.8, the contents of which are fully attributable to the present description with regard to the structural design and the mode of operation of the conveyed-products carrier 12 and the take-off conveyor 6 and also the delivery conveyor 5.

Thus, the conveyed-product carrier 12 has numerous pins 21 on its upper side, each of which has a round cross-section and projects vertically upwardly from the conveyed-product carrier 12, all of the pins 21 of the conveyed-product carrier 12 having the same length and thus forming with their free upper end surface a loading surface for depositing a portion 22 of the food product. In this case, the pins 21 are arranged in a matrix-like manner in rows and columns and each pairwise enclose between them an elongated recess 23, 24, which facilitates the removal of the portion 22 from the conveyed-product carrier 12, as will be described in detail. For this purpose, the delivery conveyor 5 has a plurality of parallel narrow knife conveyors or finger conveyors which can dive into the recesses 23, 24 in order to engage underneath and remove the portion 22 on the loading surface of the conveyor carrier 12, as can be seen from FIG. 5. FIG. 6 shows in schematic form the deposition of the portion 22 on the conveyor carrier 12, for which purpose the delivery conveyor 5 is used, which is shown here only schematically.

Furthermore, FIG. 2 shows a complete food processing installation including the cutting device 2 and the packaging machine 3. Here, the cutting device 2 delivers the portions of the food products in three parallel tracks “Track 1”, “Track 2”, “Track 3”, while the packaging machine can only process two parallel tracks “Track 1”, “Track 2”. The planar motor system 4 therefore also effects a track conversion here by converting the three conveyor tracks entering on the input-side into two conveyor tracks. For this purpose, the individual product carriers 12 are moved accordingly within the conveying surface so that there are always two product carriers 12 next to each other on the output side for product removal.

The invention is not limited to the preferred embodiment described above. Rather, a large number of variants and variations are possible which also make use of the inventive concept and therefore fall within the scope of protection. In particular, the invention also claims protection for the subject-matter and the features of the dependent claims independently of the claims referred to in each case and in particular also without the features of the main claim. The invention thus comprises various aspects of invention which enjoy protection independently of one another.

### LIST OF REFERENCE SIGNS

1 Conveyor device
2 Cutting device (slicer)
3 Packaging machine
4 Planar motor system with movable conveyors
5 Delivery conveyor
6 Take-off conveyor
7 Housing of the conveyor device
8, 9 Feet of the conveyor system
10 Holding arm of the delivery conveyor
11 Holding arm of the take-off conveyor
12 Conveyed-products carrier
13, 14 Modules of the planar motor system
15, 16 Conveyor belts of the delivery conveyor
17 Swivel axis of the delivery conveyor
18 Swivel axis of the take-off conveyor
19, 20 Conveyor belts of the take-off conveyor
21 Pins on the conveyed-products carrier
22 Portion of the food product
23, 24 Recesses in the loading surface of the conveyed-product carrier

1. A conveyor system for conveying products to be conveyed, in particular for conveying food products in a food processing installation, comprising:
at least one continuous conveyor for continuously conveying the products to be conveyed, in particular as a belt conveyor, and
a discontinuous conveyor, which is connected to the continuous conveyor on the inlet side or outlet side and takes over the conveyed products from the continuous conveyor or passes it on to the continuous conveyor.

2. The conveyor system according to claim 1,
wherein the discontinuous conveyor comprises at least one conveyed-products carrier for receiving the conveyed products,
wherein the conveyed-products carrier is optionally movable within a conveying surface along a freely programmable conveying path,
wherein the conveying surface is optionally aligned horizontally, vertically or obliquely,
wherein the discontinuous conveyor optionally comprises a contactless drive system for moving the conveyed-products carrier along the conveying path without contact between the conveyed-products carrier on the one hand and the conveying surface on the other hand,
wherein the contactless drive system is optionally a magnetic levitation system,
wherein the drive system optionally comprises a plurality of modules which are directly adjacent to one another and together form the conveying surface, and
wherein the individual modules of the drive system are optionally rectangular in each case, so that the modules can optionally be assembled without gaps to form the conveying surface.

3. The conveyor system according to claim 1, further comprising:
a delivery conveyor for depositing the conveyed products on the discontinuous conveyor, the delivery conveyor being a belt conveyor, and/or
a take-off conveyor for removing the conveyed products from the discontinuous conveyor, the take-off conveyor being a belt conveyor.

4. The conveyor r system according to claim 3,
wherein the take-off conveyor comprises a plurality of parallel conveyor belts,
wherein the conveyed-products carrier comprises, on its surface, a plurality of parallel elongate recesses into which the parallel conveyor belts of the take-off conveyor dive during a product take-off, in order to engage underneath the conveyed product located on the conveyed-products carrier and convey it away,
wherein the elongate recesses in the conveyed-products carrier are wider than the individual conveyor belts of the take-off conveyor, so that the individual conveyor belts of the take-off conveyor can dive into the individual recesses in the conveyed-products carrier,
wherein the gap between the immediately adjacent conveyor belts of the take-off conveyor is optionally greater than the distance between the immediately adjacent recesses in the conveyed-products carrier.

5. The conveyor system according to claim 4,
wherein the conveyed-products carrier comprises, on its top side, a plurality of pins which project upwards from the conveyed-products carrier and enclose the elongated recesses between them,
wherein the pins are optionally arranged in a matrix in pin rows and pin columns,
wherein the pin rows and the pin columns are optionally arranged at right angles to one another,
wherein the immediately adjacent pin rows optionally enclose the elongated recesses between them in pairs in each case,
wherein the immediately adjacent pin columns optionally enclose the elongated recesses between them in pairs in each case,
wherein the pins optionally all have the same length, and/or
wherein the pins optionally project upwardly at right angles from the loading surface, and/or
wherein the pins are optionally all aligned parallel to each other, and/or
wherein the pins optionally each have a round or angular cross-section.

6. The conveyor system according to claim 3,
wherein the delivery conveyor, the take-off conveyor and the discontinuous conveyor are integrated together in a stand-alone device,
that wherein the delivery conveyor, the take-off conveyor and the discontinuous conveyor rest optionally on a common stand, and
that wherein the discontinuous conveyor comprises a housing, the delivery conveyor and/or the take-off conveyor optionally being fastened to the housing of the discontinuous conveyor.

7. The conveyor system according to claim 3,
wherein the delivery conveyor can be pivoted between a delivery position close to the conveying surface for delivery of the conveyed products on the conveyed-products carrier and a stand-by position away from the conveying surface, in particular in the vertical direction, and/or
wherein the take-off conveyor can be pivoted between a take-off position close to the conveying surface for taking off the conveyed product from the conveyed-product carrier and a stand-by position away from the conveying surface, in particular in the vertical direction.

8. A food processing installation for processing food products, characterized by a conveyor system according to claim 1 for conveying the food products.

9. The food processing installation according to claim 8,
wherein the food processing installation comprises a cutting device for cutting the food products into slices, and/or
wherein the slices cut off by the cutting device are first received by a take-off conveyor, the take-off conveyor optionally being designed as a continuous conveyor, in particular as a belt conveyor.

10. The food processing installation according to claim 8,
wherein the food processing installation comprises a packaging machine for packaging the food products in food packaging, in particular having
a thermoforming machine for packaging the food products in a plastic film package,
a tubular bag machine for packaging the food products in tubular bags, or
a tray sealer for packaging and sealing the food products in trays, and
wherein the continuous conveyor conveys the food products into the packaging machine so that the continuous conveyor inserts the food products into the food product packages.

11. The food processing installation according to claim 8, characterized in that a buffer conveyor is arranged downstream of the cutting device in the conveying direction in order to buffer the food products, the buffer conveyor being designed as a continuous conveyor, in particular as a belt conveyor.

12. The food processing installation according to claim 8, wherein the conveyor system comprises a formatting conveyor which receives the food products on the input-side in a specific product format on the input-side, formats them and discharges them on the output-side in a specific product format on the output-side, the formatting conveyor being designed as a discontinuous conveyor.

13. The food processing installation according to claim 12,
wherein the input-side product format comprises a predetermined number of at least one conveyor track, and
wherein the product format on the output-side comprises a predetermined number of at least one conveyor track, and
wherein the number of conveying tracks in the input-side product format is different from that in the output-side product format, in particular with one of the following ratios between the number of input-side conveying tracks and the number of output-side conveying tracks:
1:2,
1:3,
1:4,
2:1,
2:3, and
2:4.

14. The food processing installation according to claim 12, wherein the output-side product format is one of the following product formats:
slice stacks of multiple stacked slices of the food product without a lateral offset between the stacked slices,
shingles made of a plurality of slices of the food product stacked one on top of the other with a lateral offset between the stacked slices,
circularly laid slices which overlap each other, or
folded slices of the food product,
staggered and overlapping shingles, each consisting of multiple slices of the food product stacked on top of each other with a lateral offset between the stacked slices,
shaved meat.
